(19) United States
(12) Patent Application Publication
(10) Pub. No.: US 2013/0233667 A1
(43) Pub. Date: Sep. 12, 2013

(54) REINFORCEMENT STRUCTURE FOR BEARINGS IN BICYCLE HUB

(71) Applicants: CHUN-HSUNG CHEN, TAICHUNG HSIEN (TW); ANTHONY SKEEN ELLSWORTH, RAMONA, CA (US)

(72) Inventors: CHUN-HSUNG CHEN, TAICHUNG HSIEN (TW); ANTHONY SKEEN ELLSWORTH, RAMONA, CA (US)

(73) Assignees: ELLSWORTH HANDCRAFTED BICYCLES, INC., RAMONA, CA (US); JOY INDUSTRIAL CO., LTD., TAICHUNG HSIEN (TW)

(21) Appl. No.: 13/413,892

(22) Filed: Mar. 7, 2012

(51) Int. Cl. F16D 15/00

(52) U.S. Cl. 192/64

(57) ABSTRACT

A reinforcement structure for bearings of a bicycle hub assembly includes a hub and an axle extends through the hub. A connection portion is defined in one end of the hub. A ratchet sleeve has a transmission portion located on one end thereof and a bearing is located in the transmission portion. Multiple slots are defined in outside of the transmission portion and the axle extends through the ratchet sleeve. A ratchet unit having multiple ratchet teeth and a ratchet ring which is connected to the connection portion. The ratchet teeth are engaged with the slots. The ratchet ring has multiple ratchet slots defined in the inner periphery thereof and the ratchet teeth are engaged with the ratchet slots. A positioning unit has a positioning member located on one side of the bearing so as to prevent the bearing from shifting axially.

### FIELD OF THE INVENTION

The present invention relates to a reinforcement structure, and more particularly, to a reinforcement structure for bearings of a bicycle hub assembly by preventing the bearings from being shifted axially to reinforce the structural strength of the hub assembly.

### BACKGROUND OF THE INVENTION

There is a hub located between the rear wheel and the clusters and a ratchet structure is located between the clusters and the hub so as to be the driving device for the rear wheel.

The conventional ratchet device generally includes a ratchet portion at one end of the ratchet sleeve and a ratchet ring is mounted to the outside of the ratchet portion. The ratchet ring has ratchets located at the inside thereof and the ratchets are located corresponding to the ratchet portion. The ratchet ring is fixed to the inside of the hub and an axle extends through the hub and the ratchet device so that the ratchet device is located at one end of the hub. Multiple bearings are located between and the ratchet sleeve, the inside of the hub and the axle to allow the ratchet sleeve to drive the hub.

The bearings located between the hub, the ratchet sleeve and the axle can be positioned on the outside or on the inside.

Taiwan Utility Model Application No. 099200971 discloses a hub which is a hollow the tubular hub and includes a groove, a resilient member, a bearing and a ratchet ring, wherein the groove is axially defined in the inside of one end of the hub. The resilient member, the bearing and the ratchet ring are engaged with the groove in sequence. The resilient member contacts the inner end of the groove and biases the bearing. The bearing has a hole defined axially therethrough. The ratchet ring has a central hole and a toothed face is defined in a recessed area of the inside of the central hole. A ratchet sleeve is located at an end of the hub and a support protrusion and a ratchet portion extend from the end having the ratchet sleeve. The ratchet portion has multiple ratchets which are located corresponding to the toothed face. An axle extends through the ratchet sleeve and is connected to the hub. The axle has one end extending through the ratchet sleeve and is rotatable relative to the ratchet sleeve.

Taiwan Utility Model Application No. 100213358 discloses a hub which has two reception holes defined in two ends thereof and an axle extends through the hub. The axle has two connection sections which are located corresponding to the reception holes of the hub. A frame has two slots defined respectively in two ends thereof and one of the slots has the first bearing received therein and the other slot receives the second bearing. The connection section of the axle extends through the frame and the two bearings. The frame is connected in series to the reception hole of the hub and the first bearing is located close to the end with the reception hole. The second bearing is located remote from the reception hole. The axle has a stepped portion which is located corresponding to the second bearing. A cap is connected of the slot where the second bearing is located so that the second bearing is positioned between the cap and the stepped portion. A washer is mounted to the axle and located close to the first bearing. A third bearing is located in the reception hole where the frame is located. The washer is sandwiched between the first and third bearings.

For Taiwan Utility Model Application No. 099200971, the bearing is located in the groove and the outside of the ratchet sleeve, the resilient member prides a force applied to the bearing from the inside toward the outside of the hub so as to ensure that the bearing is positioned. The ratchet sleeve therefore can be precisely positioned without being affected by the accumulated tolerances. For Taiwan Utility Model Application No. 100213358, the axle includes an annular step and the frame has the stepped portion, and the washer is located between the bearings, so that the bearing is positioned between the annular step, the stepped portion and the washer. The first bearing is installed in the slot of the frame and mounted to the axle.

The bearing for Taiwan Utility Model Application No. 099200971 is mounted outside of the ratchet sleeve and located in the groove of the hub, and the resilient member is located between the bearing and the groove. When the ratchet sleeve rotates and the axle is applied by a force which slightly deforms the axle, the force from the resilient member is not sufficient to prevent the bearing from being shifted by the lateral forces on two sides of the bearing. Besides, when assembling the axle, two nuts are tightly connected to two ends of the axle and when the threading forces to the two nuts are not controlled properly, the bearing cannot be smoothly operated and is easily damaged. The bearing of Taiwan Utility Model Application No. 100213358 is not affected by lateral forces, however, the bearing is simply engaged within the frame and the axle extends through the bearing. Although there is the washer on the outside of the frame, the washer is not strong enough to stop the movement of the bearing, when the frame rotates, the axle is applied by a significant force which deforms the axle slightly and the bearing shifts linearly along the axle. The movement makes the bearing be easily damaged and/or drop from the axle.

The present invention intends to provide a reinforcement structure for bearings of a bicycle hub assembly to improve the shortcomings of the conventional hubs.

### SUMMARY OF THE INVENTION

The present invention relates to a reinforcement structure for bearings of a bicycle hub assembly and comprises a hub and an axle extends through the hub. A connection portion is defined in one end of the hub. A hollow ratchet sleeve has a transmission portion located on one end thereof and a bearing is located in the end of the ratchet sleeve wherein the transmission portion is located. Multiple slots are defined in the outside of the transmission portion. The axle extends through the ratchet sleeve and the bearing. A ratchet unit has multiple ratchet teeth and a ratchet ring, wherein the ratchet teeth are located in the slots. An annular resilient member is mounted to the transmission portion and the ratchet teeth which partially protrude from the slots. The ratchet ring is connected to the connection portion. The ratchet ring has multiple ratchet slots defined in the inner periphery thereof and the ratchet teeth are engaged with the ratchet slots. A positioning unit has a positioning member located on one side of the bearing so as to stop the bearing.

The primary object of the present invention is to provide a reinforcement structure for bearings of a bicycle hub assembly and comprises a positioning unit which has a positioning member engaged with a groove in the ratchet sleeve and the positioning member stops on one side of the bearing. When the axle rotates, the bearing is stopped from shifting axially to protect the bearing.

Another object of the present invention is to provide a reinforcement structure for bearings of a bicycle hub assembly, wherein the positioning unit has a positioning part which is connected to the ratchet sleeve. The two ends of the positioning part support the ratchet sleeve and the bearing relative to the axle so as to reinforce the structural strength of the bearing.

Yet another object of the present invention is to provide a reinforcement structure for bearings of a bicycle hub assembly, wherein the ratchet sleeve and the positioning part are made by different materials so as to reduce the weight and reinforce the strength of the hub assembly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the hub assembly of the present invention;

FIG. 2 is a cross sectional view of the hub assembly of the present invention;

FIG. 3 is an exploded view to show the second embodiment of the hub assembly of the present invention;

FIG. 4 is a cross sectional view of the second embodiment of the hub assembly of the present invention;

FIG. 5 is an exploded view to show the third embodiment of the hub assembly of the present invention, and

FIG. 6 is a cross sectional view of the third embodiment of the hub assembly of the present invention.

### DETAILED DESCRIPTION OF THE PREFERRED EMBODIMENT

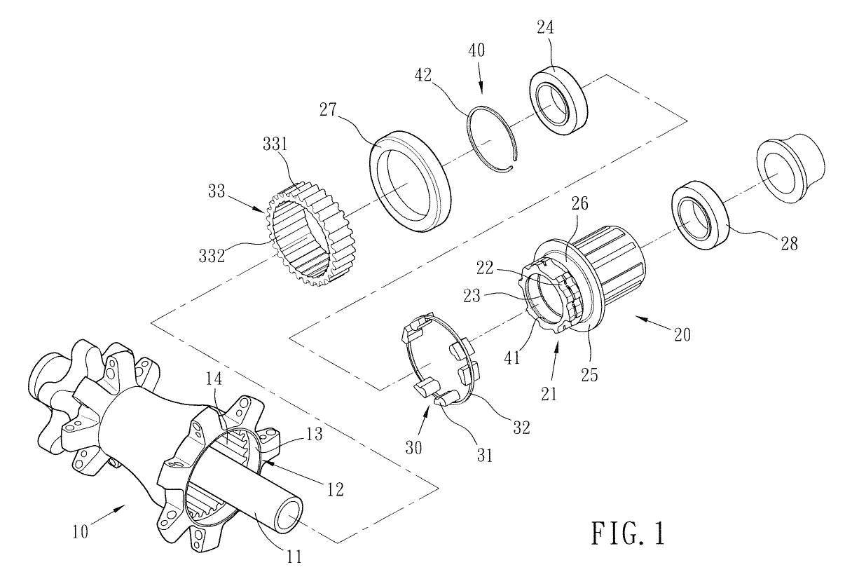

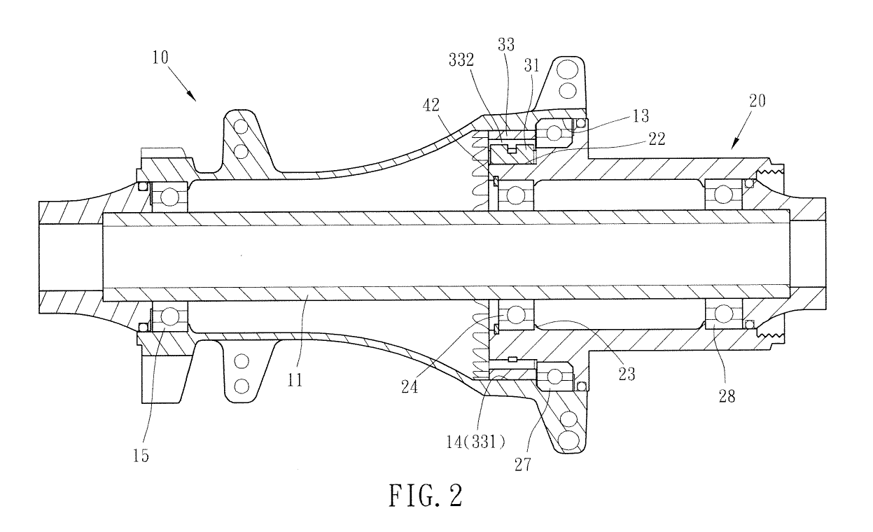

Referring to FIGS. 1 and 2, the reinforcement structure for bearings of a bicycle hub assembly of the present invention comprises a hub 10, a ratchet sleeve 20 connected with the hub 10, a ratchet unit 30 and a positioning unit 40 connected to one end of the ratchet unit 30.

An axle 11 extends through the hub 10 and a connection portion 12 is defined in one end of the hub 10. The connection portion 12 has a connection periphery 13 and a connection section 14, wherein the connection periphery 13 is located close to the open end of the hub 10 and the connection section 14 has multiple axial protrusion or axial recesses.

The ratchet sleeve 20 is a hollow sleeve and has a transmission portion 21 located on one end thereof. Multiple slots 22 are defined in the outside of the transmission portion 21 and a shoulder 23 is formed in the inner periphery of the transmission portion 21. A first bearing 24 is located in the transmission portion 21 and the first bearing 24 contacts the shoulder 23. The ratchet sleeve 20 has an annular flange 25 extending from the outer periphery thereof and a positioning section 26 is located between the flange 25 and the transmission portion 21. A second bearing 27 is mounted to the positioning section 26 and the flange 25 contacts the second bearing 27. The axle 12 extends through the ratchet sleeve 20 and the first bearing 24. A third bearing 27 is located between the first end of the axle 11 and the ratchet sleeve 20, and a fourth bearing 15 is located between the second end of the axle 11 and the hub 10.

The ratchet unit 30 has multiple ratchet teeth 31 and a ratchet ring 33. The ratchet teeth 31 are located in the slots 22. An annular resilient member 32 is mounted to the transmission portion 21 and the ratchet teeth 31 which partially protrude from the slots 22. The resilient member 32 provides a return force to the ratchet teeth 31. The first ratchet ring 33 has a second connection portion 331 on the outside thereof and the second connection portion 331 is located corresponding to the connection section 14. The second connection portion 331 has multiple axial recesses or axial protrusions so as to be connected with the connection section 14. The ratchet ring 33 has multiple ratchet slots 332 defined in the inner periphery thereof and the ratchet teeth 31 are engaged with the ratchet slots 332.

The positioning unit 40 has a positioning groove 41 defined in the transmission portion 21 and located close to the open end of the positioning groove 41. A positioning member 42 is engaged with the positioning groove 41 so as to stop the first bearing 24. The positioning member 42 is a C-clip.

When the axle 11 rotates, the force due to the rotation tends to move the first bearing 24 along the axial direction of the axle 11 and the positioning member 42 stops the potential movement of the first bearing 24.

When assembling, the first ratchet ring 33 is connected to the first connection portion 12 on one end of the hub 10 and the first bearing 24 is installed in the ratchet sleeve 20. The positioning member 42 is engaged with the positioning groove 41 to contact one side of the first bearing 24. The second bearing 27 is mounted onto the ratchet sleeve 20 and the ratchet teeth 31 are engaged with the slots 22. The axle 11 extends through the ratchet sleeve 20 to engage the ratchet teeth 31 with the ratchet slots 332 of the first ratchet ring 33. The third and fourth bearings 28, 15 are respectively connected to two ends of the axle 11.

The positioning member 42 is engaged with the positioning groove 41 to contact one side of the first bearing 24 to prevent the first bearing 24 from shifting toward the axial direction of the ratchet sleeve 20, while the first bearing 24 is rotatable relative to the axle 11.

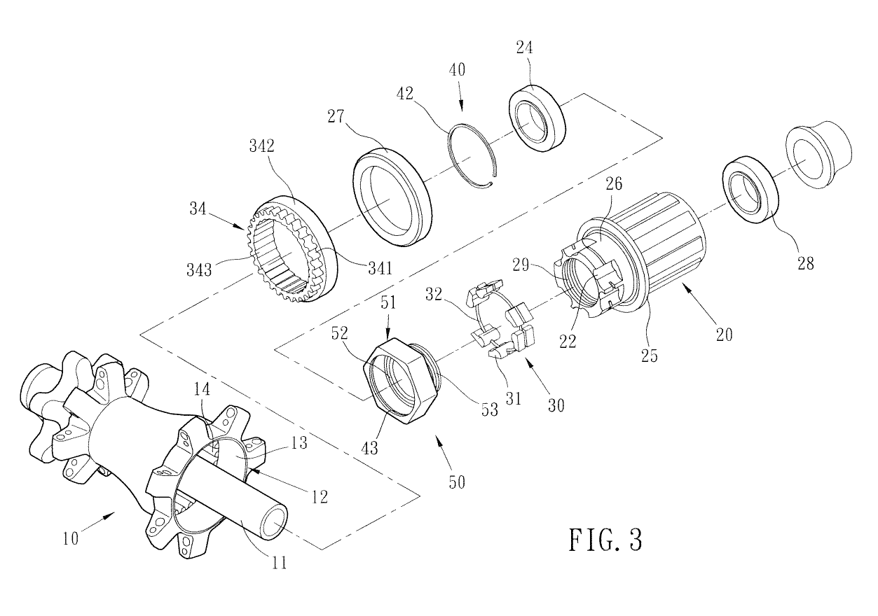

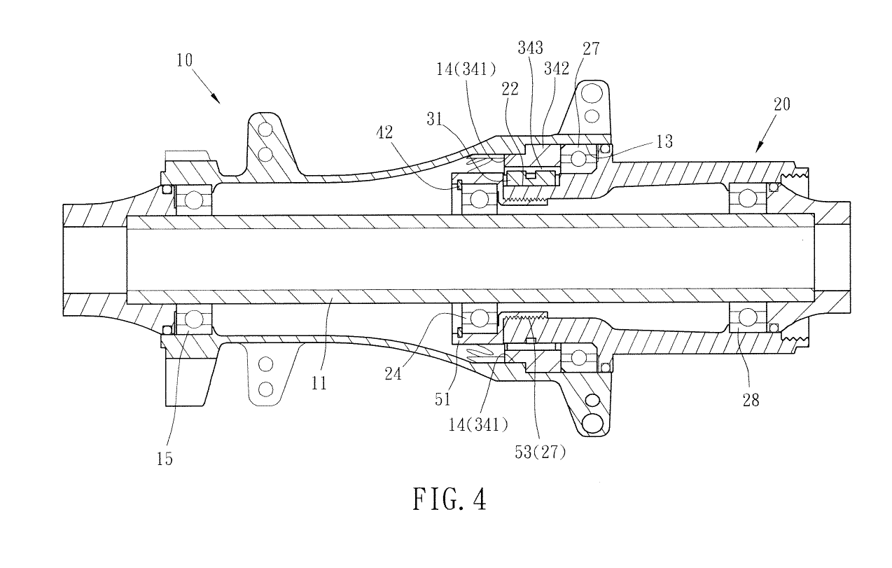

As shown in FIGS. 3 and 4, the second embodiment of the present invention is disclosed. The positioning unit 40 has a first position part 50 which is a tubular part and has a first connection part 51 on a first end thereof. The second ratchet ring 34 has a neck 342 and a second connection portion 341. The second connection portion 341 has multiple axial recesses or axial protrusions so as to be connected with the connection section 14. The neck 342 is located corresponding to the connection periphery 13 and has smooth outer surface. The second ratchet ring 34 has multiple slots 343 in the inner periphery thereof. The first position part 50 is a tubular part and has a first connection part 51 on the first end thereof and a shoulder 52 is formed in the first connection part 51. The first bearing 24 is located in the first connection part 51 and the shoulder 52 contacts one side of the first bearing 24. A positioning groove 43 is defined in the first connection part 51 and located remote from the shoulder 52. A positioning member 42 is engaged with the positioning groove 43 so as to stop the first bearing 24. The first position part 50 has a second connection part 53 on the second end thereof. The ratchet sleeve 20 has a third connection part 29 located therein and connected to the second connection part 53. The second and third connection parts 53, 29 have threads so as to be connected with each other. The ratchet sleeve 20 and the first positioning part 50 are two parts and made by different materials, the material of the ratchet sleeve 20 is harder than that of the first positioning part 50. The ratchet sleeve 20 can be made by aluminum or other metallic material so as to reduce the weight. The first positioning part 50 can be made by iron, stainless steel to have better strength. The neck 342 of the second ratchet ring 34 is designed to increase the length of the slots 343 to have better durable feature. The two ends of the first positioning part 50 support the ratchet sleeve 20 and the first bearing 24 relative to the axle 11 so that the axle 11 can bear higher load.

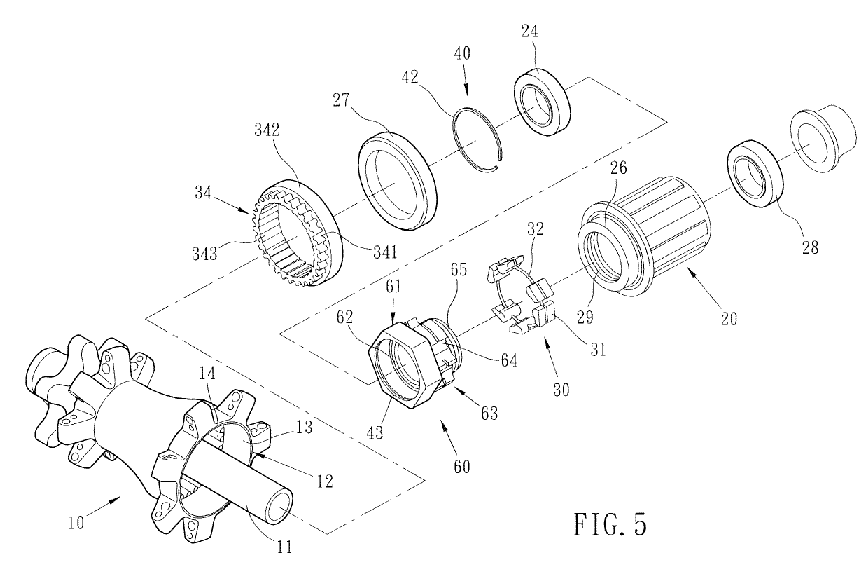

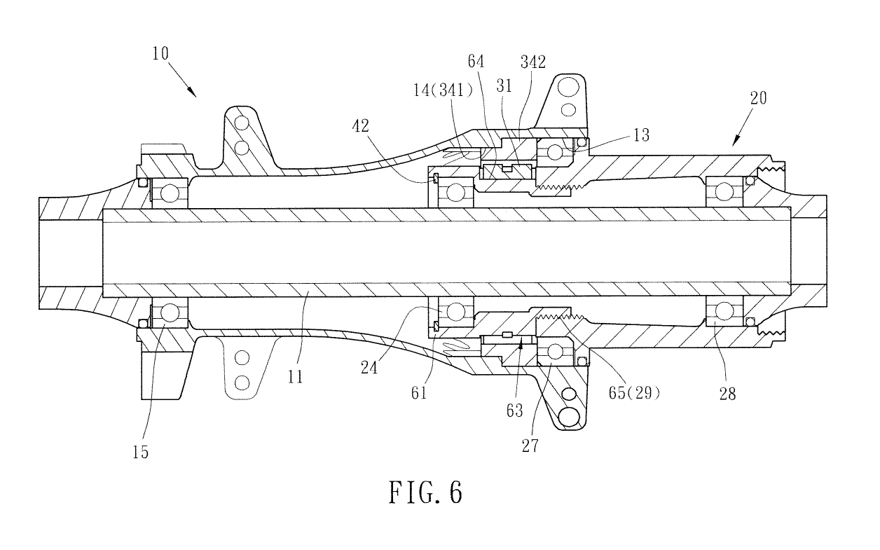

As shown in FIGS. 5 and 6, the third embodiment of the present invention is disclosed. The positioning unit 40 has a second position part 60 which is a tubular part and has a first connection part 61 on the first end thereof. A shoulder 62 is formed in the inner periphery of the first connection part 61 and the first bearing 24 is located in the first connection part 61. The shoulder 62 contacts the first bearing 24. A positioning groove 43 is defined in the first connection part 61 and located remote from the shoulder 62. A positioning member 42 is engaged with the positioning groove 43 so as to contact the other side of first bearing 24. The second position part 60 has the transmission portion 63 and a second connection part 65 on the second end thereof. The transmission portion 63 has multiple slots 64 defined in the outer periphery thereof so that the ratchet teeth 31 are engaged with the slots 64. The ratchet sleeve 20 has a third connection part 29 located therein and connected to the second connection part 65. The second and third connection parts 65, 29 have threads so as to be connected with each other. The ratchet sleeve 20 and the second positioning part 60 are two parts and are made by different materials, the material of the second positioning part 60 is harder than that of the ratchet sleeve 20. The ratchet sleeve 20 can be made by aluminum or other metallic material so as to reduce the weight. The second positioning part 60 can be made by iron, stainless steel to have better strength.

The positioning member 42 of the positioning unit 40 is engaged with the inside of one end of the ratchet sleeve 20 and contacts one side of the first bearing 24, so that when the axle 11 rotates and applies the force to the first bearing 24, the first bearing 24 does not move axially along the ratchet sleeve 20, so that the first bearing 24 is protected. The positioning unit 40 further has a position part connected with the ratchet sleeve 20 and the first bearing 24 is located in the positioning part. The two ends of the position part support the first bearing 24 and the ratchet sleeve 20 relative to the axle 11.

The ratchet sleeve 20 and the second positioning part 60 are made by different materials. The ratchet sleeve 20 is made by lighter material so as to reduce the weight. The second positioning part 60 is made by harder material than that of the ratchet sleeve 20 to have better strength. The neck 342 of the second ratchet ring 34 is designed to increase the length of the slots 343 to have larger contact area and have better durable feature.

The positioning member 42 of the positioning unit 40 is engaged with the inside of one end of the ratchet sleeve 20 and contacts one side of the first bearing 24 so as to prevent the first bearing 24 from axially moving along the ratchet sleeve 20. The first bearing 24 is therefore protected. The positioning unit 40 further has a positioning part for being connected with the ratchet sleeve 20. The ratchet sleeve 20 and the positioning part are made by different materials to have light weight and strong strength.

While we have shown and described the embodiment in accordance with the present invention, it should be clear to those skilled in the art that further embodiments may be made without departing from the scope of the present invention.

What is claimed is:

1. A reinforcement structure for bearings of a bicycle hub assembly, comprising:
a hub having an axle extending therethrough and a connection portion defined in an end of the hub;
a ratchet sleeve being a hollow sleeve and having a transmission portion located on an end thereof, a bearing located in the end of the ratchet sleeve wherein the transmission portion is located, multiple slots defined in an outside of the transmission portion, the axle extending through the ratchet sleeve and the bearing;
a ratchet unit having multiple ratchet teeth and a ratchet ring, the ratchet teeth located in the slots, an annular resilient member mounted to the transmission portion and the ratchet teeth which partially protrude from the slots, the ratchet ring connected to the connection portion, the ratchet ring having multiple ratchet slots defined in an inner periphery thereof and the ratchet teeth engaged with the ratchet slots, and
a positioning unit having a positioning member located on one side of the bearing so as to stop the bearing.

2. The reinforcement structure as claimed in claim 1, wherein the connection portion has a connection section which has multiple axial protrusions or axial recesses, the ratchet unit has a first ratchet ring which has a second connection portion on an outside thereof and the second connection portion is located corresponding to the connection section, the second connection portion has multiple axial recesses or axial protrusions so as to be connected with the connection section.

3. The reinforcement structure as claimed in claim 1, wherein the bearing located in the end of the ratchet sleeve where the transmission portion is located is a first bearing, the transmission portion has a shoulder formed in an inner periphery thereof and the first bearing is located in the transmission portion, the first bearing contacts the shoulder, the ratchet sleeve has an annular flange extending from an outer periphery thereof, a positioning section is located between the flange and the transmission portion, a second bearing is mounted to the positioning section and the flange contacts the second bearing, a third bearing is located between a first end of the axle and the ratchet sleeve, a fourth bearing is located between a second end of the axle and the hub.

4. The reinforcement structure as claimed in claim 1, wherein the positioning unit has a positioning groove defined in the transmission portion and located close to the open end of the positioning groove, a positioning member is engaged with the positioning groove so as to stop the bearing.

5. The reinforcement structure as claimed in claim 4, wherein the positioning member is a C-clip.

6. The reinforcement structure as claimed in claim 1, wherein the connection portion has a connection periphery and a connection section, the connection periphery is located close to an open end of the hub and the connection section has multiple axial protrusions or axial recesses, the ratchet unit has a second ratchet ring which has a neck and a second connection portion respectively located corresponding to the first connection portion, the second ratchet ring has multiple slots in an inner periphery thereof, the neck is located corresponding to the connection periphery, the second connection portion has multiple axial recesses or axial protrusions located corresponding to the connection section.

7. The reinforcement structure as claimed in claim 1, wherein the positioning unit has a first position part which is a tubular part and has a first connection part on a first end thereof, the bearing is located in the first connection part, a positioning groove is defined in the first connection part and a positioning member is engaged with the positioning groove so as to stop the bearing, the first position part has a second connection part on a second end thereof, the ratchet sleeve has a third connection part located therein and connected to the second connection part.

8. The reinforcement structure as claimed in claim 7, wherein the ratchet sleeve and the first positioning part are made by different materials, the material of the ratchet sleeve is harder than that of the first positioning part.

9. The reinforcement structure as claimed in claim 1, wherein the positioning unit has a second position part which is a tubular part and has a first connection part on a first end thereof, the bearing is located in the first connection part, a positioning groove is defined in the first connection part and a positioning member is engaged with the positioning groove so as to stop the bearing, the second position part has the transmission portion and a second connection part on a second end thereof, the transmission portion has multiple slots defined in an outer periphery thereof, the ratchet sleeve has a third connection part located therein and connected to the second connection part.

10. The reinforcement structure as claimed in claim 9, wherein the ratchet sleeve and the second positioning part are made by different materials, the material of the second positioning part is harder than that of the ratchet sleeve.
